(19) United States
(12) Patent Application Publication
(10) Pub. No.: US 2007/0236512 A1
(43) Pub. Date: Oct. 11, 2007

(54) METHOD AND SYSTEM FOR IMAGE OVERLAY PROCESSING

(75) Inventors: Po Chun Huang, Hsinchu Hsien (TW); Chi-Hsien Chang, Taichung Hsien (TW); Tien-Yu Chang, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/690,871

(22) Filed: Mar. 26, 2007

Related U.S. Application Data
(60) Provisional application No. 60/791,068, filed on Apr. 11, 2006.

(51) Int. Cl. G09G 5/00

(52) U.S. Cl. 345/634; 345/667

(57) ABSTRACT

An image processing system is provided. A first interface receives a first pixel of a first image. A second interface receives a second pixel of a second image. An overlay processor retrieves one of the first pixels and the corresponding second pixel, generates a selection signal, and switches to the first pixel or the second pixel according to the selection signal.

### CROSS REFERENCE TO RELATED APPLICATIONS

This application claims priority of U.S. Provisional Patent Application Ser. No. 60/791,068. The contents of the provisional applications are hereby incorporated by reference.

### BACKGROUND

The invention relates to image processing, and in particular to methods and systems for image overlay processing.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

FIG. 1 illustrates a schematic view of a block diagram of a conventional system implementing a frame overlay process. FIGS. 2A˜2C show images processed by the system of FIG. 1. A system 100 comprises an image sensor 110, a resizer 120, an overlay frame buffer 130, an image frame buffer 140, an image overlay engine 150, and an overlaid image frame buffer 160. An image 111 is generated and sent from image sensor 110. The image 111 is received and processed by resizer 120, and a resized image 121 is generated thereby. The resized image 121 is shown in FIG. 2A. The resized image 121 is sent to and stored in image frame buffer 140. An overlay frame 131 is stored in overlay frame buffer 130. The overlay frame 131 is shown in FIG. 2B. When an overlay frame 131 is to be added to image 121, image 121 and overlay frame 131 are retrieved from the image frame buffer 140 and overlay frame buffer 130, respectively. The retrieved image 121 and overlay frame 131 are processed in image overlay engine 150, and an overlaid image 151 is generated thereby. The overlaid image 151 is shown in FIG. 2C. The overlaid image 151 is stored in overlaid image frame buffer 160 for further use.

According to the conventional overlay process, 3 buffers are required to store images, overlay frames, and overlaid images, respectively. Required storage resources increase with augmenting of image resolution.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An image processing system is provided. The image processing system comprises a first interface, a second interface, and an overlay processor. The first interface receives a first pixel of a first image. The second interface receives a second pixel of a second image. The overlay processor retrieves one of the first pixels and the corresponding second pixel, generates a selection signal, and switches to the first pixel or the second pixel according to the selection signal.

Also provided is a method of image processing. A first image is provided, comprising a plurality of first pixels. A second image is provided, comprising a plurality of second pixels. One of the first pixels and the corresponding second pixel are retrieved. A selection signal is generated. It is switched to the first pixel or the second pixel according to the selection signal.

### BRIEF DESCRIPTION OF DRAWINGS

The invention can be more fully understood by reading the subsequent detailed description and examples with references made to the accompanying drawings, wherein:

FIG. 1 illustrates a schematic view of a block diagram of a conventional system implementing a frame overlay process;

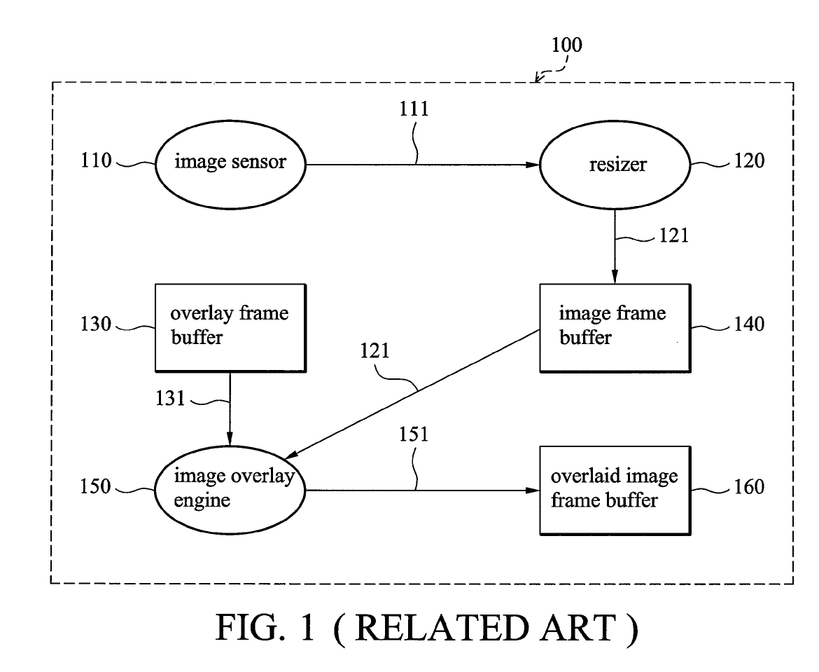

FIGS. 2A˜2C show images processed by the system of FIG. 1;

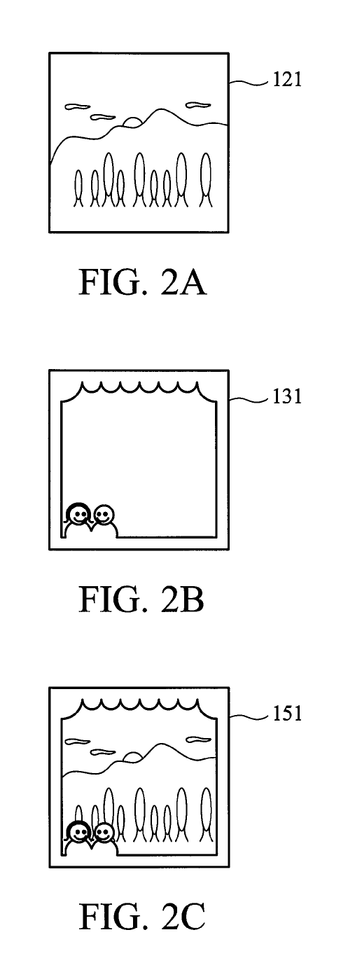

FIG. 3 is a schematic view of an image processing system;

FIGS. 4A and 4B are flowcharts of an embodiment of a method of image processing;

FIG. 5 is a schematic view of an embodiment of a horizontal scaling process;

FIG. 6 is a schematic view of another embodiment of a vertical scaling process; and

FIG. 7 shows an embodiment of vertical and horizontal magnified frames.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

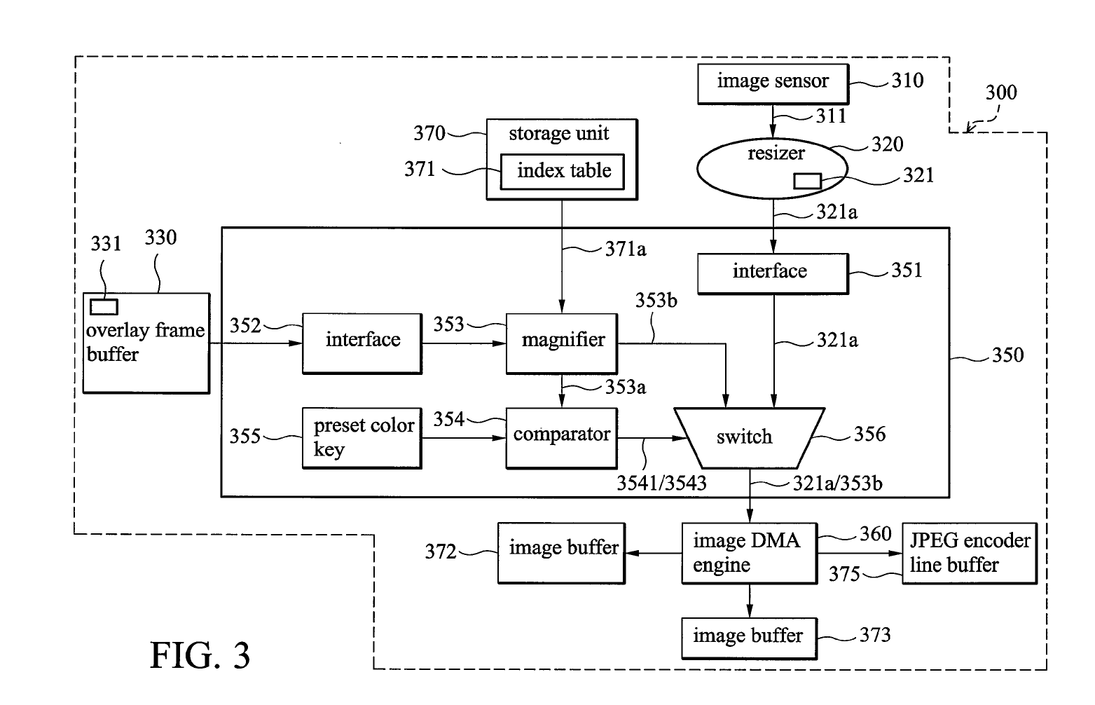

FIG. 3 is a schematic view of an image processing system. An image processing system 300 comprises an image sensor 310, resizer 320, overlay frame buffer 330, overlay processing system 350, image DMA (direct memory access) engine 360.

A frame image 331 is stored in overlay frame buffer 330. The frame image 331 comprises a plurality of pixels, each of which can be indexed or non-indexed. For example, pixels of frame image 331 are arranged in order sequentially. Accordingly, each of the pixels can be identified according to a storage position in which it is stored. Color keys corresponding to the pixels are stored in the storage unit 370.

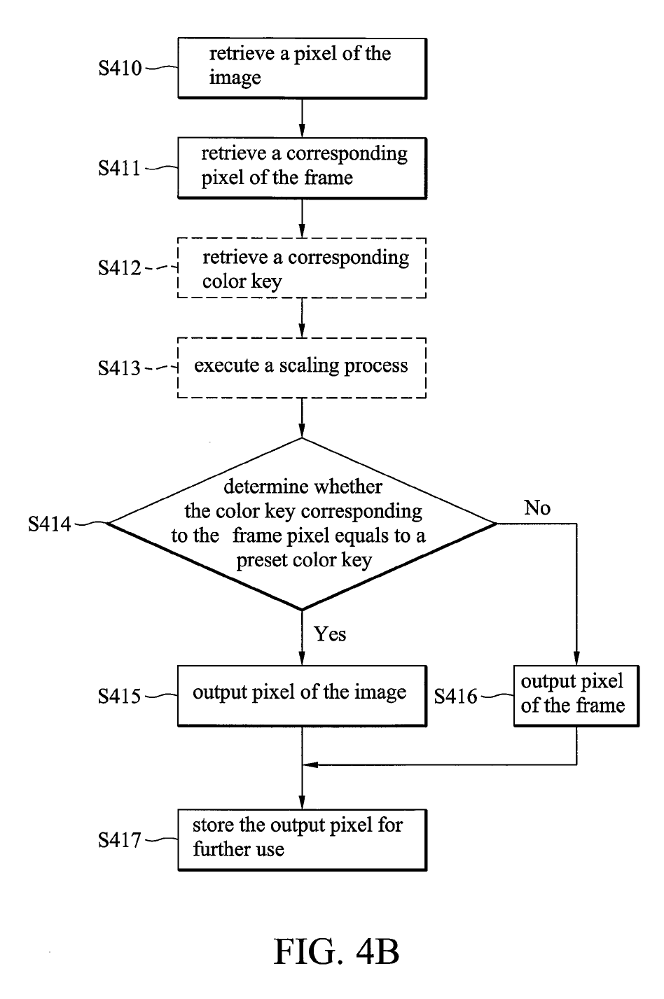

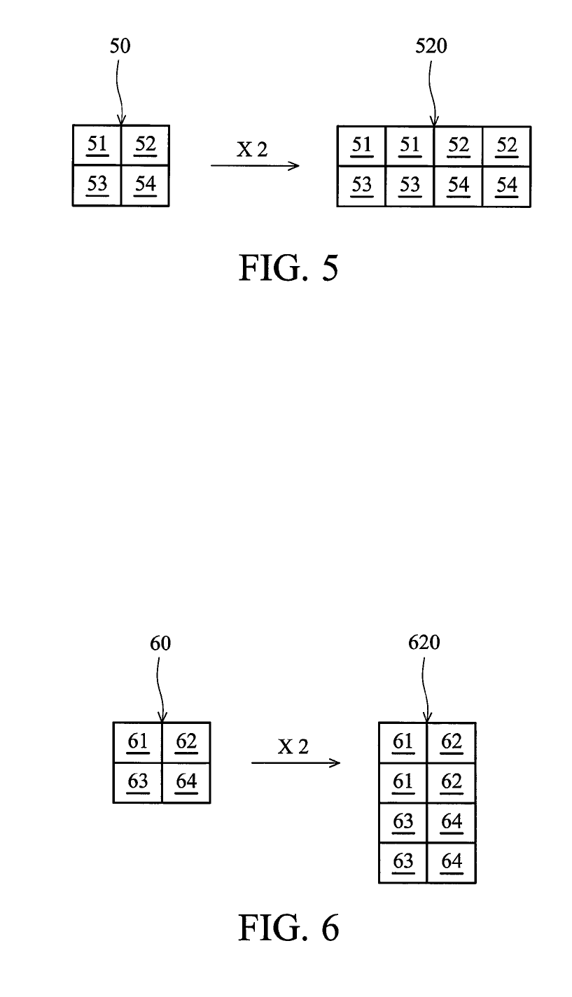

An image 311 is generated and sent from image sensor 310. Image 311 comprises a plurality of pixels. Image 311 is received and processed by resizer 320, and a resized image 321 of desired resolution is generated thereby. Pixels of the resized image 321 are stored in a line buffer sequentially, and one of the pixels is sent to and processed by overlay processing system 350 at a time. Accordingly, there is no need to store the whole resized image in advance. When a pixel 321a of the resized image 321 is received by interface 351, a corresponding pixel of image 331 corresponding thereto is retrieved from overlay frame buffer 330. The pixels of image 331 are received, one at a time, by interface 352. If the pixel of image 331 is indexed, a corresponding color key 371a is retrieved from the index table 371 stored in storage unit 370. If image 331 is not the same size as image 321, a scaling processing is required. Generally, the size of frame image 331 is equal to or less than the size of image 321. A magnifier 353, therefore, is required to overlay image 331 on image 321. Operations of magnifier 353 are described in detail later, as shown in FIG. 5 and FIG. 6. After the processing of magnifier 353, color key 353a corresponding to pixel 321a is sent to comparator 354, and corresponding pixel 353b is sent to switch 356. A preset color key 355 is retrieved by comparator 354, and is compared with color key 353a. The preset color key 355 specifies a transparent pixel in image 331. When the color key 353a is equal to preset color key 355, a signal 3541 is sent to switch 356, otherwise a signal 3543 is sent. Both pixels 321a and 353b are sent to switch 356. When switch 356 receives signal 3541 indicating that the pixel 353b is transparent, switch 356 outputs pixel 321a to image DMA engine 360. When switch 356 receives signal 3543 indicating that the pixel 353b is not transparent, switch 356 outputs pixel 353b to image DMA engine 360.

The pixel received by image DMA engine 360 is then sent to other units for further use. For example, the pixel can be sent to image buffer 372 for video encoding, to image buffer 373 for camera preview, or to JPEG encoder line buffer 375 for further JPEG encoding.

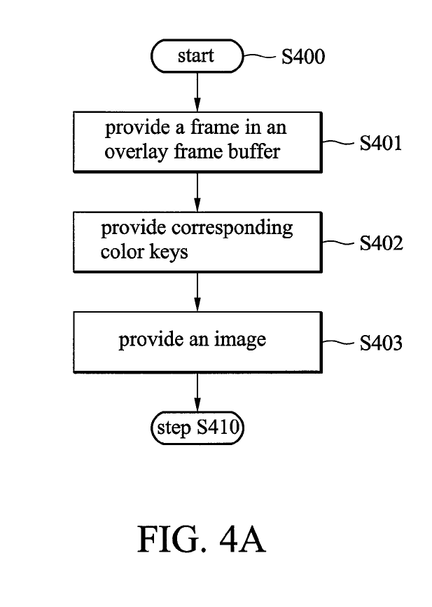

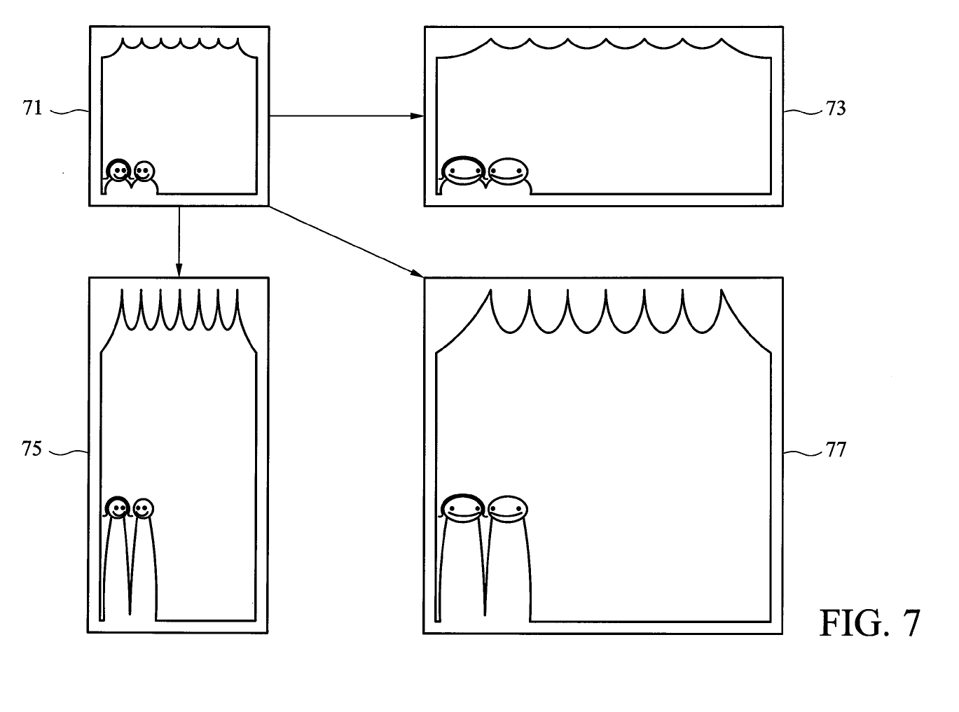

FIGS. 4A and 4B are flowcharts of an embodiment of a method of image processing. The method is implemented in an image processing system (such as the image processing system 300 of FIG. 3), beginning with a start step (step S400). A frame image (hereinafter refers to as a frame) is provided in an overlay frame buffer (step S401). The frame comprises a plurality of pixels, each of which can be indexed or non-indexed. For example, the frame can be a frame 71 shown in FIG. 7. For example, pixels of frame image 331 are arranged in order sequentially. Accordingly, each of the pixels can be identified according to a storage position in which it is stored. Color keys corresponding to the pixels are stored in a storage unit (step S402). An image is provided, comprising a plurality of pixels (step S403). When the frame provided in step S401 is to overlay on image provided in step S403, the method proceeds to step S410 (as shown in FIG. 4B).

A pixel of the image is retrieved in step S410, and a corresponding pixel of the frame is retrieved in step S411. If the pixel of the frame is indexed, a corresponding color key is retrieved in step S412. If the frame and the image are of different sizes, a scaling process (step S413) is executed. Generally, the size of the frame is equal or less than the size of the image. The scaling process is described in detail in FIG. 5 and FIG. 6. After the scaling process (if any), it is determined whether the color key corresponding to the frame pixel equals to a preset color key (step S414). The preset color key specifies a transparent pixel. When the color key of the frame pixel equals to the preset color key, the method proceeds to step S415, otherwise, to step S416. In step S415, pixel of the image is output. In step S416, pixel of the frame is output. In step S417, the output pixel is stored for further use.

FIG. 5 is a schematic view of an embodiment of a horizontal scaling process. Using FIG. 7 as an example, frame 71 is magnified horizontally to generate frame 73. FIG. 5 shows a simplified example of a horizontal magnification. Frame 50 comprise pixels 51, 52, 53, and 54, each of which is retrieved and processed sequentially in the order of pixels 51, 52, 53, and then 54. Here, frame 50 is magnified 2 times horizontally and each pixel is read 2 times. When frame 50 is magnified N times horizontally, each pixel is read N times. After the magnification process, frame 50 is presented as frame 520. For overlaying process, when frame 50 is magnified N times horizontally, each pixel is used for the comparison step S414 N times.

FIG. 6 is a schematic view of another embodiment of a vertical scaling process. Using FIG. 7 as an example, frame 71 is magnified vertically to generate frame 75. FIG. 6 shows a simplified example of a vertical magnification. Frame 60 comprise pixels 61, 62, 63, and 64, each of which is retrieved and processed sequentially in the order of pixels 61, 62, 63, and then 64. Here, frame 60 is magnified 2 times vertically, each line of pixels is read 2 times. When frame 60 is magnified N times vertically, each line of pixels is read N times. In the overlaying process, when frame 60 is magnified N times vertically, each line of pixels is used for the comparison step S414 N times.

Referring to FIG. 7, when frame 71 is magnified both horizontally and vertically, frame 77 is presented by implementing both processes of FIGS. 5 and 6.

Methods and systems of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of image processing, comprising:
providing a first image comprising a plurality of first pixels;
providing a second image comprising a plurality of second pixels;
retrieving one of the first pixels and the corresponding second pixel;
generating a selection signal; and
switching to the first pixel or the second pixel according to the selection signal.

2. The method of claim 1, further comparing the retrieved second pixel with a preset color key, generating the third pixel identical with the retrieved first pixel when the retrieved second pixel comprises the preset color key, and generating the third pixel identical with the retrieved second pixel when the retrieved second pixel does not comprise the preset color key.

3. The method of claim 1, further magnifying the second image horizontally by retrieving each of the second pixels in a line of the second image repetitively.

4. The method of claim 1, further magnifying the second image vertically by retrieving the second pixels in a line of the second image repetitively.

5. The method of claim 1, further sending the third pixel to an image buffer for video encoding.

6. The method of claim 1, further sending the third pixel to a camera preview image buffer.

7. The method of claim 1, further sending the third pixel to a JPEG encoder line buffer.

8. An image processing system, comprising:
a first interface receiving a first pixel of a first image;
a second interface receiving a second pixel of a second image; and
an overlay processor retrieving one of the first pixels and the corresponding second pixel, generating a selection signal, and switching to the first pixel or the second pixel according to the selection signal.

9. The system of claim 8, wherein the overlay processor further comprises:
a comparator comparing the second pixel with a preset color key; and
a switch unit outputting the third pixel identical with the received first pixel when the received second pixel comprises the preset color key, and outputting the third pixel identical with the received second pixel when the received second pixel does not comprise the preset color key.

10. The system of claim 8, further comprising a magnifier magnifying the second image horizontally by overlaying each of the second pixels in a line of the second image and the first pixel repetitively.

11. The system of claim 8, further comprising a magnifier magnifying the second image vertically by overlaying the second pixels in a line of the second image and the first pixel repetitively.

12. The system of claim 8, further comprising an image buffer for video encoding receiving the third pixel for further video encoding.

13. The system of claim 8, further comprising a camera preview image buffer receiving the third pixel for further camera preview.

14. The system of claim 8, further comprising a JPEG encoder line buffer receiving the third pixel for further JPEG encoding.
